(19) United States
(12) Patent Application Publication
(10) Pub. No.: US 2008/0060628 A1
(43) Pub. Date: Mar. 13, 2008

(54) Self-lubricating piston

(76) Inventor: John A. Heimbecker, Cibolo, TX (US)

Correspondence Address: William F. Ryann, Ste. 1629, 115 E. Travis St., San Antonio, TX, 78205, US

(21) Appl. No.: 11/801,488

(22) Filed: May 10, 2007

Related U.S. Application Data
(63) Continuation-in-part of application No. 11/517,159, filed on Sep. 7, 2006.

(51) Int. Cl. F02F 1/20

(52) U.S. Cl. 123/65 PE

(57) ABSTRACT

An engine assembly including a piston for rectilinear reciprocation within a cylinder. Rectilinear reciprocation of the piston allows for a sealing off of a fuel chamber such that fuel may be maintained and delivered to a combustion chamber independent of any lubrication oil to be employed at the interface of the piston and an inner wall of the cylinder. Additionally, the piston may be considered self-lubricating or monolithic in nature due to the presence of passageways for transferring engine fluids therethrough.

### PRIORITY CLAIM

This Patent Document is a Continuation-In-Part of application Ser. No. 11/517,159, Stroke Control Assembly (John A. Heimbecker), filed Sep. 7, 2006.

### BACKGROUND

Embodiments described relate to engines. In particular, embodiments of assemblies for clean burning two stroke engines are described.

### BACKGROUND OF THE RELATED ART

Internal combustion and other engines are employed to convert the reciprocating, generally rectilinear, movement of pistons into a rotating movement of a crankshaft. A piston within a cylinder may be fired, applying the downward force of a piston's power stroke through a rod and to a rotable crankshaft. In this manner, a unidirectional rotation of the crankshaft may be achieved. The rotating crankshaft in turn may be coupled to power output for the engine allowing a user to obtain the benefit of power from the engine.

As described above, the crankshaft may provide the power output for the engine by its rotation in one direction during the power stroke of the piston. However, the continued rotation of the crankshaft may then perform the function of a crank, guiding the return of the pistons into position for the firing of another power stroke. Thus, if the mass of the crankshaft and its associated flywheel are sufficient, the crankshaft may enable both the power output of the engine and the guided return of pistons for the continued running of the engine.

The above described technique of transforming a generally rectilinear movement of pistons into the rotating movement of a crankshaft to obtain power from an engine is effective. However, in order to take advantage of such a technique different types of fluids must be provided to the piston within the cylinder. For example, a conventional fuel may be provided to a combustion chamber region of the cylinder for the above-noted firing of the piston. Thus, the indicated power stroke may be achieved. Additionally, a conventional lubricating oil may be introduced to the combustion chamber to minimize friction between the reciprocating piston and the cylinder wall.

Unfortunately, the fuel and lubricating oil are not entirely compatible. For example, the fuel is selected based on combustability characteristics in order to achieve the noted piston firing. The lubricating oil however, is selected based on lubrication and durability properties. In fact, given the high heat and pressure environment in which the lubricating oil is employed, resistance to breakdown and combustion may be very important characteristics of the oil.

In order to account for the general incompatibility of the different engine fluids, a four stroke engine provides segregated lubrication. Here, a reservoir of the lubricating oil is maintained to one side of the piston, generally in a crankcase therebelow, whereas the fuel is supplied to the combustion chamber at the opposite side of the piston. However, attempted segregation of the different engine fluids in a two stroke engine is a more challenging problem. In fact, two stroke engines have generally relied on the intentional desegregation of fluids. Therefore, at some point, the combustion chamber may be exposed to the lubricating oil in lubricating the interface of the piston and the cylinder sidewall. In order to minimize the impact of the presence of lubricating oil in the combustion chamber, engine choices may be limited to very small oil burning two stroke engines or relatively inefficient but cleaner operating four stroke engines as described herebelow.

Historically, smaller engines such as those found in motorcycles, jet skis, snow-mobiles, weed-eaters, chain saws, power washers, and older lawnmowers, have employed two stroke engines techniques, whereby a small quantity of lubricating oil is thrown directly into the combustion chamber as the piston reciprocates relative thereto. The oil is then picked up by the piston and squeezed across the cylinder wall as the piston reciprocates. A two stroke engine is fired with each and every approach of the piston toward the combustion chamber. As a result, some of the oil provided to the combustion chamber is burned along with the fuel during the firing of the piston. Burned oil of this nature is considered a significant pollutant. Therefore, such two stroke engines are limited in size as noted above, in part to meet EPA standards. In fact, as EPA standards become stricter over time, the use of two stroke engines is becoming increasingly rare, even for smaller machinery. Furthermore, even with pollutant and EPA considerations aside, the allowance of burning oil within the combustion chamber sacrifices the performance of the engine to a degree. For example, the fluid delivered to the combustion chamber may be a mix of between about 25 and 50:1, fuel to oil, at any given point in time. This failure to maintain a regular supply of substantially pure fuel for clean combustion comes at a cost to engine performance. Additionally, lubricating oil buildup may occur at spark plugs that are employed for the noted combustion, similarly affecting engine performance.

In order to provide a substantially cleaner burning alternative to the two stroke engine described above, a four stroke engine may be employed. Larger engines such as those found in automobiles are generally of the four stroke variety. A four stroke engine employs a host of sophisticated features such as a cam, lifters, timing chain, and specialized valves in order to divide strokes of the piston relative to the combustion chamber into distinct phases. For example, one period of reciprocation of the piston relative to the combustion chamber may be employed for the purpose of receiving and compressing fuel while at the same time disseminating lubrication oil. During this period, no oil may be provided to the combustion chamber, because the dissemination occurs below a compression ring. Similarly, during a different period of reciprocation of the piston relative to the combustion chamber, combustion may occur and spent fuel may be exhausted from the chamber while disseminating lubricating oil below a compression ring. Thus, combustion may take place in a substantially clean manner (i.e. free of burning oil). Unfortunately, achieving this ‘clean burning’ combustion also comes at a performance cost to the engine. That is, combustion within the chamber is of a limited duration. In fact, rather than allowing combustion upon each return of the piston toward its top dead center position relative to the chamber, combustion takes place only every fourth time the piston approaches this position. Thus, the majority of the time, the piston advances and retreats relative to the chamber without receiving the power of combustion therefrom. Further still, a sophisticated array of features, all of which are susceptible to wear and breakdown, must be maintained in order to ensure the proper timing of combustion chamber phases while maintaining segregated lubrication within the chamber. Even at that, it is still only the benefit of an inherently inefficient four stroke engine that may be realized.

### SUMMARY

An engine is provided with a piston for reciprocating in a cylinder. The cylinder includes a combustion chamber that is isolated from a fuel chamber by the piston. The fuel chamber may be employed to accommodate fuel to the substantial exclusion of a lubricating oil.

### BRIEF DESCRIPTION OF THE DRAWINGS

FIG. 1 is a side cross sectional view of an embodiment of a self-lubricating piston assembly.

FIG. 2 is a top cross sectional view of a self-lubricating piston of the assembly of FIG. 1 taken from section lines 2-2.

FIG. 3 is a perspective view of the self-lubricating piston of FIGS. 1 and 2.

FIG. 4A is a side cross sectional view of the self-lubricating piston assembly of FIG. 1 in a fuel transfer position.

FIG. 4B is a side cross sectional view of the self-lubricating piston assembly of FIG. 1 in a fuel compression position.

FIG. 4C is a side cross sectional view of the self-lubricating piston assembly of FIG. 1 in a fuel combustion position.

FIG. 4D is a side cross sectional view of the self-lubricating piston assembly of FIG. 1 in a top dead center position.

FIG. 4E is a side cross sectional view of the self-lubricating piston assembly of FIG. 1 in an exhausting position.

FIG. 5 is a flow chart summarizing an embodiment of employing a self-lubricating piston assembly as depicted in FIGS. 4A-4E.

### DETAILED DESCRIPTION

Embodiments are described with reference to certain self-lubricating piston assemblies. The assemblies may include a monolithic piston with passageways therethrough to accommodate and direct lubrication oil to an interface of the piston and a cylinder wall of the assembly. In this manner the piston may be considered self lubricating. Given a self-lubricating piston of this nature, such assemblies may also employ truly rectilinear reciprocation of the piston thereby allowing a fuel supply to.be sealed off from the lubrication oil source as detailed herein. In fact, the fuel may also be transported through alternative passageways in the piston without mixing with lubrication oil or requiring that overly sophisticated valving or timing techniques be employed.

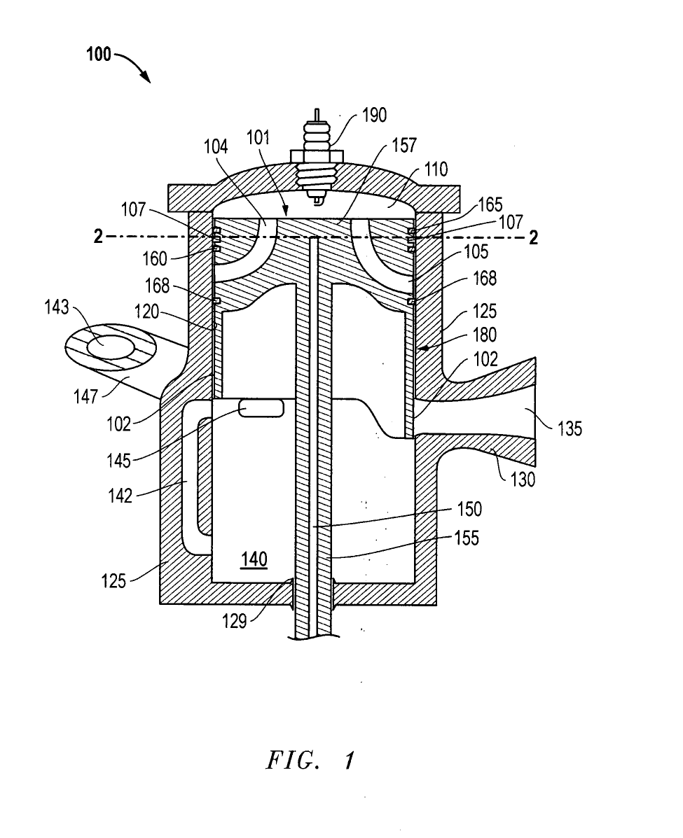

Referring now to FIG. 1, a side cross sectional view of an embodiment of a self-lubricating piston assembly 100 is shown. The depicted assembly 100 is a portion of an engine including a cylinder block 125 having a cylinder with a self-lubricating piston 101 for reciprocation therein. In the embodiment shown, the self-lubricating piston 101 is configured for rectilinear reciprocation within the cylinder. For example, in one embodiment the self-lubricating piston 101 is coupled to a stroke control assembly as detailed in application Ser. No. 11/517,159, Stroke Control Assembly (John A. Heimbecker), filed Sep. 7, 2006. However, in other embodiments, alternative measures may be taken to achieve a truly rectilinear stroke of the self-lubricating piston 101. Regardless, embodiments described herein take advantage of this rectilinear stroke to provide assemblies in which lubrication oil may be substantially isolated from fuel during operation without the requirement of four stroke or similarly inefficient or overly complex mechanics.

Continuing with reference to FIG. 1, a combustion chamber 110 is separated from a fuel chamber 140 by a head 157 of the self-lubricating piston 101. The fuel chamber 140 is configured to obtain clean fuel through a fuel inlet 145. The fuel chamber 140 is configured to retain and transfer the fuel substantially free of lubrication oil contamination. That is, as noted above, the self-lubricating piston 101 is configured to move in a rectilinear manner, straight up and straight down. Rather than allowing the rod 155 to move laterally during reciprocation, for example to turn a crankshaft, a truly rectilinear motion of the rod 155 is maintained. This straight up and straight down motion of the piston rod 155 allows for sealing off of the fuel chamber at the seal 129 thereby avoiding contamination with lubrication oil, for example from a crankcase therebelow. This isolated clean fuel may then be transferred from the fuel chamber 140 to the combustion chamber 110 via a transfer port 142 substantially free of lubrication oil contamination (e.g. unlike a conventional two stroke engine).

The interface 180 of the piston head 157 and a wall 120 of the cylinder may be prone to the effects of friction in an operating assembly 100. Therefore, the delivery of a lubrication oil to this location may be of benefit. In the case of a conventional two stroke engine lubrication oil may be thrown into the combustion chamber 110 along with fuel in order to provide this lubrication. However, in the assembly 100 shown and described herein, fuel may be transferred from the fuel chamber 140 to the combustion chamber 110 substantially free of any lubrication oil. Therefore, an alternative route of delivering lubrication oil to the interface 180 is called for. This is where the self-lubricating nature of the self-lubricating piston 101 comes into play as described below.

Continuing with reference to FIG. 1, lubrication oil is delivered to the interface 180 of concern through a lubrication channel 150 and recess 107 of the self-lubricating piston 101. Thus the lubrication oil is delivered without contaminating the fuel chamber 140 or mixing with clean fuel and resulting in ‘dirty’ (i.e. as would be the case with a conventional two stroke engine). In fact, the delivery of the lubrication oil directly to the interface 180 of concern as opposed to the combustion chamber 110 or cylinder at large allows the assembly to substantially avoid dirty combustion of lubrication oil altogether without the requirement of non-power producing piston stroking or sophisticated timing features found in conventional four stroke engines. Rather, embodiments described herein include an assembly 100 wherein each and every reciprocation of the self-lubricating piston 101 may include power producing combustion without any significant burning of lubrication oil.

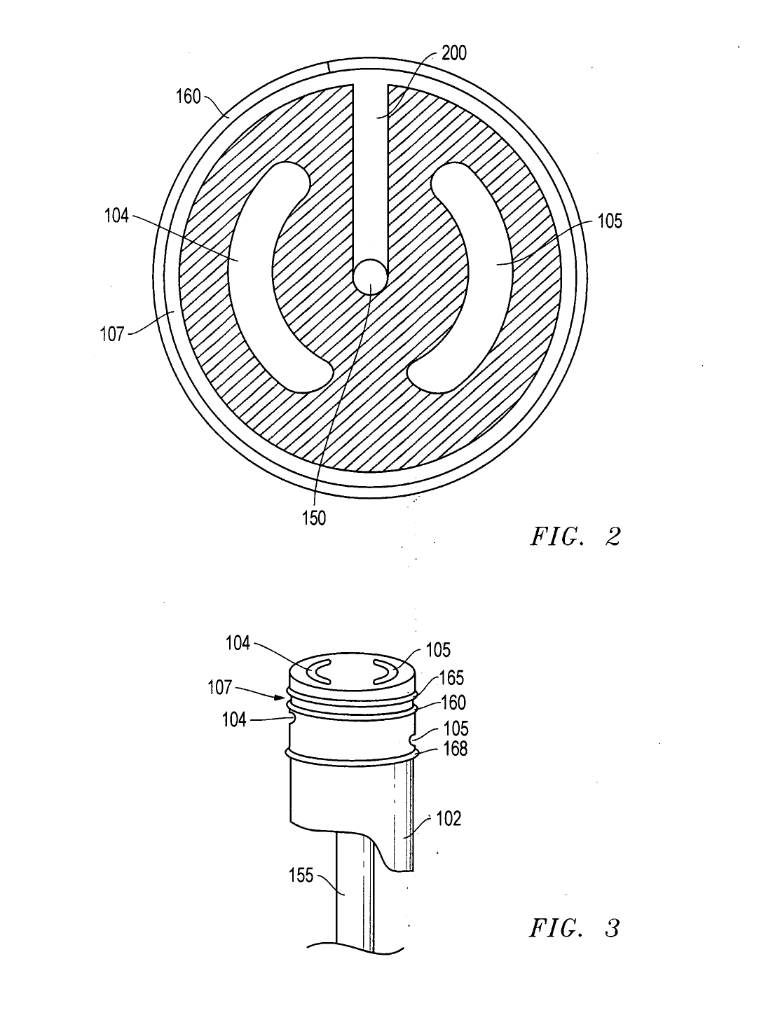

Continuing with reference to FIG. 1, additional features of the self-lubricating piston assembly 100 are depicted which are described in greater detail with reference to FIGS. 2, 3, and 4A-4E hereinbelow. These features include a fuel line 147 with a fuel channel 143 leading to the above noted fuel inlet 145 terminating in the fuel chamber 140. As detailed further herein, fuel from the fuel chamber 140 may be transferred to the combustion chamber 110 where a spark plug 190 may be employed to initiate combustion of fuel and provide power to the piston 101. In the embodiment shown the self-lubricating piston 101 may define the separation between fuel 140 and combustion 110 chambers along with the dimensions thereof (i.e. see the piston skirt 102 relative to the fuel chamber 140). The self-lubricating piston 101 is of a monolithic configuration with pathways 104, 105 for transfer of fluid between chambers 140, 110 and to an exhaust line 130 through an exhaust channel 135. Rings 160, 168 may be provided to close off these pathways 104, 105 when the transfer of fluid is to be terminated. Other pathways 150, 107 are provided to deliver a lubrication oil to an interface 180 as indicated above. Again, certain rings 160, 165 may be employed to substantially restrict the flow of lubrication oil to areas outside of the interface 180.

Continuing now with reference to FIGS. 1-3, the self-lubricating piston 101 is depicted. In particular, the monolithic nature of the piston 101 is apparent with lubricating 150, 107, 200 and fluid transfer 104, 105 pathways carved therethrough. As indicated above, rings 160, 165, 168 may be employed in conjunction with a cylinder wall 120 to control access to these pathways as the piston 101 progresses from position 101 to position during operation of the assembly 100. The monolithic nature of the piston with pathways 104, 105, 150, 107, 200 carved therethrough allows the assembly 100 to operate without the requirement of a host of sophisticated valving, timing and other features in order to transfer fluids relative to chambers 140, 110 of the assembly 100 or within the piston 101 itself.

As alluded to above, and with particular reference to the lubricating pathways 150, 107, 200 depicted in FIGS. 1-3, the interface 180 of the piston 101 and cylinder wall 120 may be a location susceptible to natural frictional wear as the assembly 100 operates. This type of wear may be minimized to a degree by the rectilinear nature of the movement of the piston 101 during operation. Nevertheless, a lubricating oil may be delivered to the interface 180 in order to ensure the avoidance of complete frictional breakdown. The lubricating oil may be delivered to the interface 180 from a crankcase or other oil reservoir below the fuel chamber 140. For example, as shown in FIG. 1, a lubrication channel 150 of the piston rod 155 may be in communication with a crankcase below the fuel chamber 140 by conventional means. Between about 20 and about 40 pounds of pressure may be employed to direct lubrication oil up the lubrication channel 150 and toward the interface 180.

Continuing with added reference to FIG. 2, which is taken from section 2-2 of FIG. 1, the lubrication channel 150 is shown terminating within the piston head 157 and short of the compression chamber 110. A lateral channel 200 is provided to couple the lubrication channel 150 to a lubricating recess 107 at the outer surface of the self-lubricating piston 101. With particular reference to FIGS. 1 and 3, the lubricating recess 107 is disposed between upper and lower oil rings 165, 160 for substantially retaining the lubrication oil that is present at the recess 107. It is from this location that the interface 180 is lubricated as the piston 101 reciprocates within the cylinder. That is, as the self-lubricating piston 101 moves up and down within the cylinder, lubricating oil is delivered to the interface 180 and squeegeed up and down the wall 120 by the oil rings 165, 160. It is in this respect that the piston 101 is said to be self-lubricating, that is, by reliance on the lubricating pathways 150, 107, 200 through the monolithic body of the piston 101 as opposed to simply mixing lubricating oil with fuel or employing sophisticated timing, valving, or other complex lubricating mechanisms.

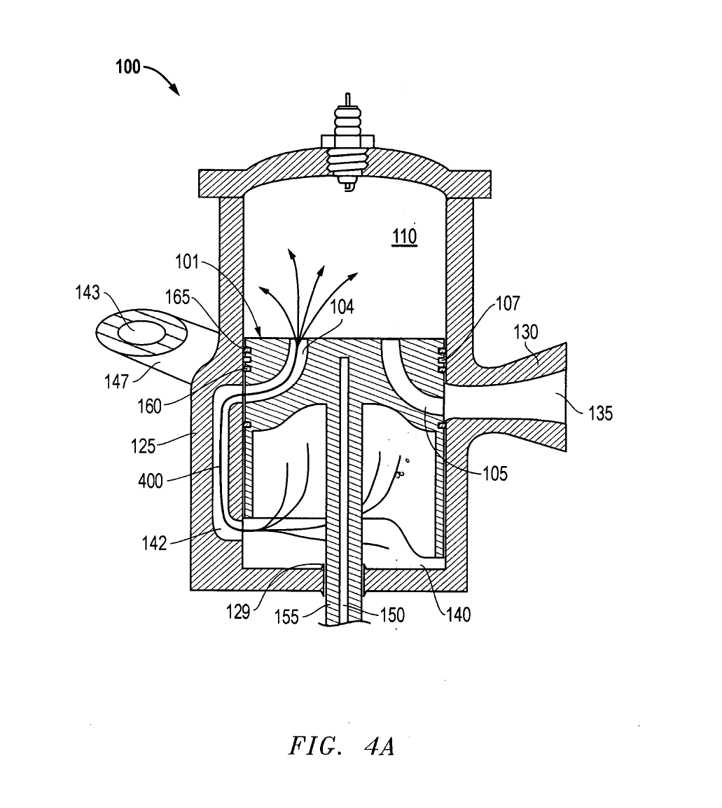

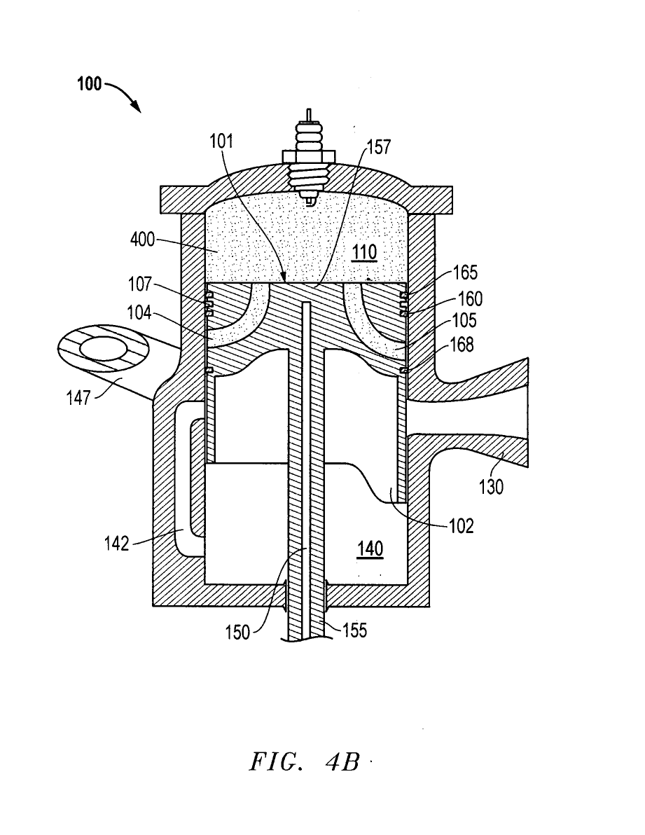

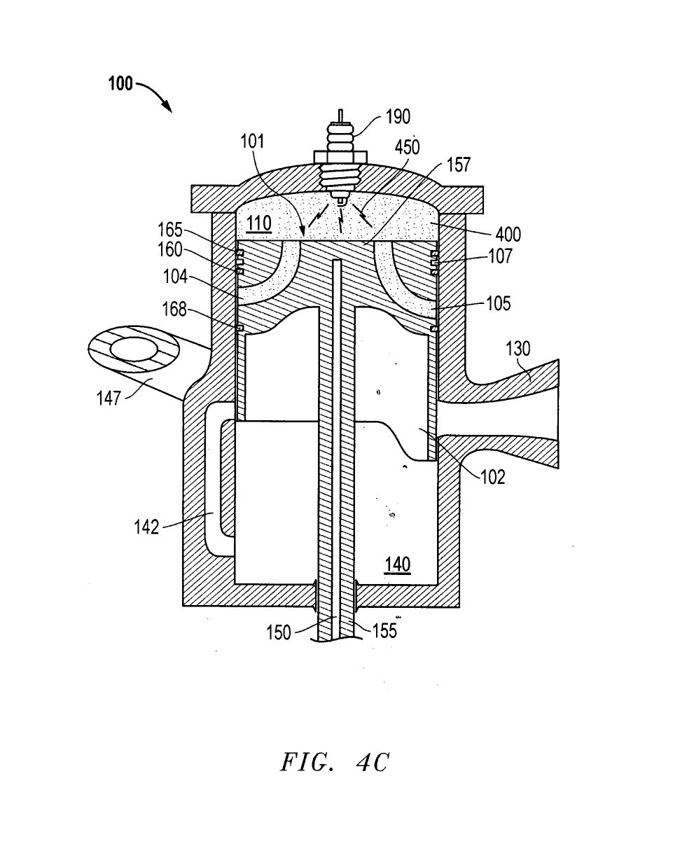

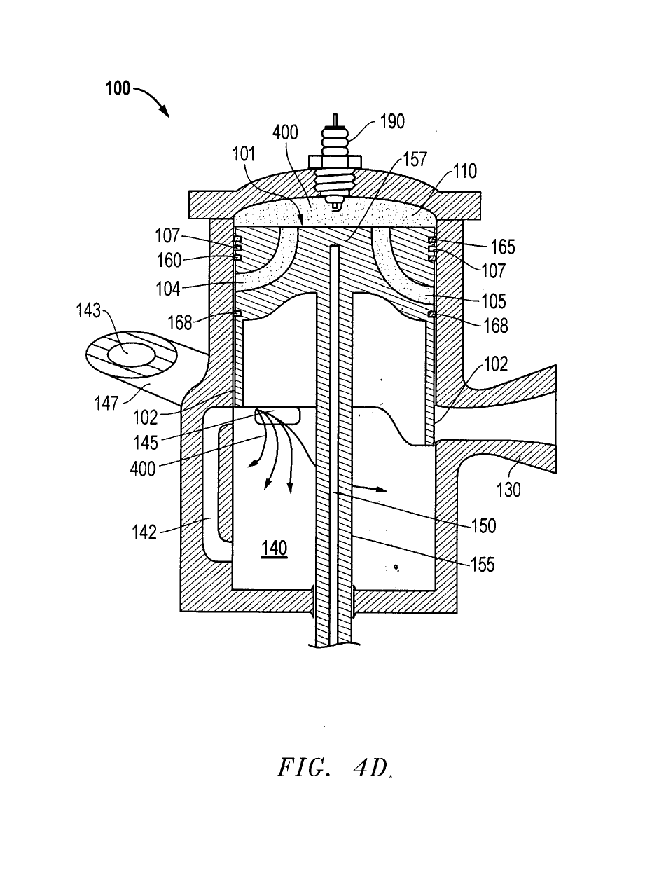

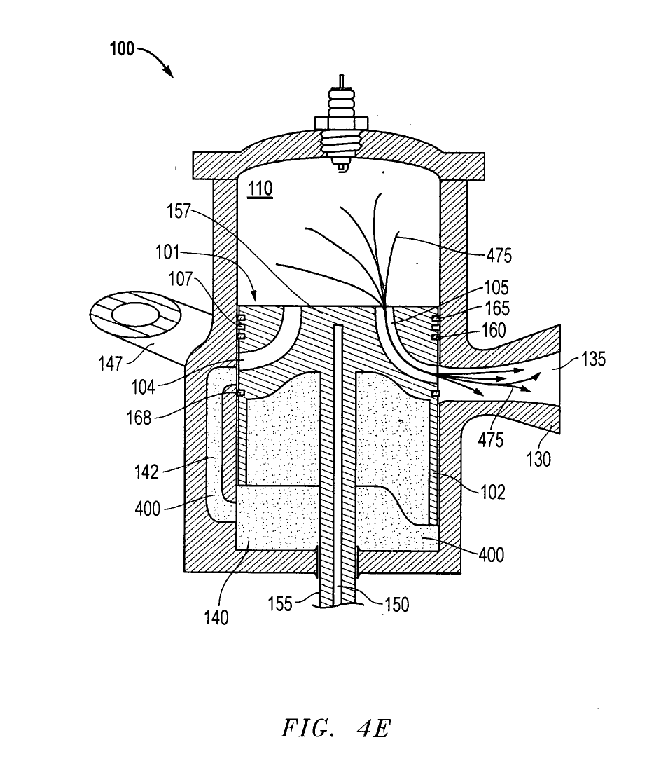

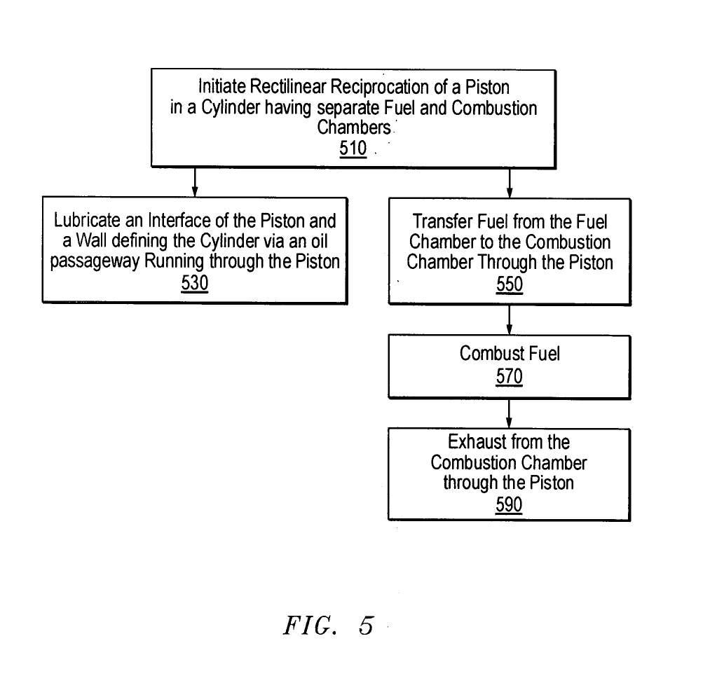

Continuing now with reference to FIGS. 4A-4E an embodiment of operating the self-lubricating piston assembly 100 is depicted as the piston 101 progresses from position to position. In particular, fuel 400 is shown moving from the fuel chamber 140 to the combustion chamber 110 where it is converted to exhaust 475 and directed out an exhaust line 130. The fuel chamber 140 is replenished with fuel 400 as the piston 101 reciprocates and the process continues. The transfer and movement of fuel 400 into and through the assembly 100 takes place in a cohesive and seamless manner, without the requirement of specialized valving or overly sophisticated timing features. As with the self-lubricating characteristics of the piston 101 described above, this seamless transfer of fuel 400 is made possible by pathways (104 and 105 in this case) through the monolithic piston 101 in conjunction with features of the cylinder body 125 itself. This movement of fuel 400 through the assembly 100 during operation is depicted with reference to FIGS. 4A-4E as detailed herebelow.

Continuing now with reference to FIG. 4A, the piston 101 is shown in a fuel transfer position. From this position the piston 101 forces fuel 400 within the fuel chamber 140 through a fuel transfer port 142 and to the combustion chamber 110 above the piston 101. That is, the piston 101 is thrust downward during a power stroke to the point that a fuel nostril 104 is aligned with the fuel transfer port 142 through the body 125 of the cylinder. Thus, the fuel 400 is allowed to escape through the transfer port 142 via the fuel nostril 104 that serves as a passageway through the head of the monolithic piston 101 and into the combustion chamber 110. In other words, pressure generated by the downward thrust of the piston 101 correlates with an alignment of the fuel nostril 104 and the transfer port 142 thereby transferring fuel 400 from the fuel chamber 140 to the combustion chamber. Of note is the fact that the downward thrust of the piston 101 occurs in a rectilinear manner, thereby allowing the fuel chamber 140 to remain closed off at the seal 129, thus directing the pressurized fuel 400 to escape via the transfer port 142 as described.

Once fuel 400 is delivered to the combustion chamber 110, the piston 101 continues its rectilinear reciprocation eventually taking it to a fuel compression position as shown in FIG. 4B (e.g. back up in the direction of the combustion chamber 110). As the piston 101 moves in this direction, the pressure in the fuel chamber 140 is reduced. However, the fuel chamber 140 remains sealed with no fuel 400 able to exit or enter, for example, via the fuel line 147 (see FIG. 4D). An occlusive skirt 102 is provided extending below the piston head 157 and covering points of access to the fuel chamber 140 to ensure that it remains sealed during the depicted fuel compression. These covered points of access may include the transfer port 142, an exhaust line 130 and the noted inlet port 145.

As shown in FIG. 4C, the piston 101 continues its upstroke to a fuel combustion position at which time a spark 450 is generated in the combustion chamber 110 by the spark plug 190 to initiate combustion of the fuel 400 therein. The combusting fuel 400 continues to be compressed by the upstroke of the piston 101. However, the combustion chamber 11 0 remains sealed throughout, just as in the fuel compression position as depicted in FIG. 4B. In fact, the above described fuel nostril 104 is sealed at the wall 120 of the cylinder by the lower oil ring 160 immediately thereabove and a compression ring 168 therebelow. The same is true of an exhaust nostril 105 through the head 157 of the monolithic piston 101 (see below). The vacuum in the fuel chamber 140 continues to increase.

Eventually, the reciprocating piston 101 will come to a top dead center position within the cylinder as depicted in FIG. 4D. From this position the combustion of the fuel 400 as described above will result in pressure driving the piston 101 to a downward power stroke as described below. At top dead center however, pressure within the fuel chamber 140 is at its minimum. Furthermore, the skirt 102 extending below the piston head 157 has been raised to the point that a fuel inlet 145 is exposed. Thus, fuel 400 may be delivered to the fuel chamber 140 as depicted. In this manner, fuel 400 may be made available for subsequent transfer to the combustion chamber 110 as described above.

As indicated above, a downward power stroke of the piston 101 may be driven by the noted combustion of fuel 400. Thus the piston 101 may proceed downward to the exhaustion position depicted in FIG. 4E as the fuel 400 continues to be spent and converted to exhaust 475. At this point, an exhaust nostril 105 through the head 157 of the monolithic piston 101 may align with an exhaust line 130 thereby allowing the exhaust 475 to exit an exhaust channel 135 thereof. In one embodiment, the downward power stroke of the piston 101 may continue to a point where the fuel nostril 104 again aligns with the transfer port 142 to begin allowing fuel 400 to move to the combustion chamber 110 from the fuel chamber 140 while the last of the exhaust 475 is directed out the exhaust line 130 (not shown). Of note is the fact that in such an embodiment, the nostrils 104, 105 are oriented with respect to the combustion chamber 110 such that the incoming fuel 400 may scavange out the remaining exhaust 475 furthering its exit from the combustion chamber 110 as described above.

In the above described progression of the monolithic self-lubricating piston 101 from position to position, fuel intake and exhaust are achieved without interruption or contamination by lubrication oil. Nevertheless, the piston 101 may be fired each and every time it approaches a top dead center position (such as in the combustion position depicted in FIG. 4C). Thus, the power output obtainable from the assembly 100 is more efficient than that what may be achieved from a conventional four stroke engine while also providing a clean burning of fuel 400 not obtainable from a conventional two stroke engine.

The above detailed clean burning and efficient power output of the assembly 100 are obtainable in part due to the self-lubricating nature of the piston 101 itself. That is, with such a piston 101 that delivers its own lubrication oil to the interface 180 of the piston 101 and the wall 120 of the cylinder, there is no requirement to provide separate sophisticated valving or inefficient timing features to the assembly 100, nor is there the need to mix lubrication oil with fuel 400 in an undesirable manner to provide the necessary lubrication. Rather, the self-lubricating piston 101 may be configured of a monolithic nature with passageways (i.e. nostrils 104, 105) permitting fuel transfer and exhausting at the appropriate times as detailed above.

Of note in the above described reciprocation of the piston 101 is the fact that the lubrication oil is provided to the interface 180 throughout. That is, the lubrication oil is provided from the lubricating recess 107 to the wall 120 of the cylinder such that it is squeegeed up and down the wall 120 by the rings 160, 165. While the assembly 100 may be configured to allow an insubstantial amount of lubrication oil to pass beyond rings 160, 165, the amount may be kept to a minimum so as to avoid any significant combustion thereof. In fact, in the embodiments depicted herein the above described progression of the reciprocating piston 101 proceeds without the lubricating recess 107 ever traversing the transfer port 142 or the exhaust channel 135. Therefore, no significant amount of lubrication oil is permitted to mix with fuel 400 or to be dispensed through the exhaust line 130.

Referring now to FIG. 5, a flow-chart summarizing the above described progression of the self-lubricating piston 101 during operation is depicted. Namely, as a rectilinear reciprocation of a piston is achieved as indicated at 510, unique techniques for lubricating and transferring fuel and exhaust may be employed. For example, the piston may be self-lubricating by way of a lubrication oil channel or passageway therethrough (see 530). Given the rectilinear nature of the reciprocation, a dedicated fuel chamber may be employed to contain fuel to the substantial exclusion of any lubricating oil. Thus, fuel may be cleanly transferred through the piston to a combustion chamber for combustion as indicated at 550 and 570. As noted at 590, exhaust from this combustion may then be exhausted through the piston and away from the assembly.

The embodiments described herein achieve a clean burning engine without requiring any interruption in piston firing during the cycling of the engine. The inherent incompatibility of fuel and lubricating oil fails to become a significant concern due to the manner in which each is delivered to their destination within the cylinder that houses the piston. As a result, larger engines may be employed that involve no interruption in piston firing during cycling and without significant concern over the burning of lubrication oil. Such engines also avoid concern over oil buildup in parts such as at spark plugs. Thus, these engines may operate more efficiently for longer periods of time. Embodiments described herein also provide techniques for transferring and delivering engine fluids to a piston-cylinder wall interface or a combustion chamber thereabove without requiring any sophisticated valving, lifters, cams or other parts necessary to engine operation that might be susceptible to wear and breakdown.

Although exemplary embodiments described above include particular techniques for isolating and transferring engine fluids relative to a cylinder housing a piston with engine fluid passageways therethrough, additional embodiments and features are possible. For example, in an alternate embodiment to those described hereinabove the fuel chamber may be sealed to contain fuel to the substantial exclusion of lubrication oil and yet be employed to transfer that fuel to the combustion chamber through a passageway that does not necessarily include a channel through the piston. Furthermore, many other changes, modifications, and substitutions may be made without departing from the scope of the described embodiments.

I claim:

1. An engine comprising a piston for reciprocation within a cylinder, the piston for isolating a combustion chamber of the cylinder from a fuel chamber of the cylinder, said fuel chamber to accommodate fuel to the substantial exclusion of lubricating oil.

2. The engine of claim 1 wherein the reciprocation is rectilinear reciprocation.

3. The engine of claim 2 wherein the cylinder is defined by a cylinder block, said piston comprising:
a head for the isolating;
a rod coupled to said head for traversing the fuel chamber; and
a seal in the cylinder block at the fuel chamber and about said rod to allow the substantial exclusion.

4. The engine of claim 3 wherein said head comprises a fuel nostril therethrough and the cylinder block comprises a transfer port therethrough for alignment with said fuel nostril to provide a passageway between the fuel chamber and the combustion chamber.

5. The engine of claim 3 wherein said head comprises an exhaust nostril therethrough, the cylinder coupled to an exhaust line for alignment with said exhaust nostril to provide a passageway for exhausting from the combustion chamber.

6. The engine of claim 1 wherein the cylinder is defined by a cylinder block, said piston further comprising:
a head for the isolating; and
a skirt coupled to said head for occluding one of a transfer port through the cylinder block to the fuel chamber and an exhaust line coupled to the cylinder for exhausting therefrom.

7. A self-lubricating piston assembly comprising:
a cylinder block with an inner wall defining a cylinder; and a self-lubricating piston for reciprocation within the cylinder at an interface of the inner wall, said self-lubricating piston having a channel therethrough for delivering lubrication oil to the interface during the reciprocation.

8. The self-lubricating piston assembly of claim 7 wherein said self-lubricating piston comprises:
a rod coupled to a reservoir of the lubrication oil; and
a head coupled to said rod for the reciprocation at the interface, the channel in fluid communication with the reservoir and an outer surface of said head for the delivering.

9. The self-lubricating piston assembly of claim 8 wherein the reservoir is accommodated by a crankcase.

10. The self-lubricating piston assembly of claim 8 wherein the channel comprises a recess circumferentially about said head at the outré surface for the delivering.

11. The self-lubricating piston assembly of claim 10 wherein said head further comprises:
an upper oil ring circumferentially about the outer surface; and
a lower oil ring circumferentially about the outer surface the recess disposed between said upper ring and said lower ring to substantially retain lubrication oil therebetween.

12. A monolithic piston for reciprocating within a cylinder and having a passageway therethrough to allow one of a transferring of fuel between a fuel chamber of the cylinder and a combustion chamber of the cylinder, an exhausting from the combustion chamber, and a lubricating of an interface between the piston and an inner wall of a cylinder block defining the cylinder.

13. The monolithic piston of claim 12 further comprising a head to accommodate the passageway from a side surface adjacent the wall to an upper surface adjacent the combustion chamber, the cylinder block having a channel terminating at the wall for aligning with the passageway for one of said transferring and said exhausting.

14. The monolithic piston of claim 13 further comprising:
a first ring circumferentially about said head; and
a second ring circumferentially about said head, the passageway disposed between said first ring and said second ring at the side surface, said first ring and said second ring to isolate the passageway from the channel when not aligning.

15. The monolithic piston of claim 12 further comprising:
a head at the interface; and
a rod coupled to said head and a reservoir of lubrication oil, the passageway to deliver the lubrication oil from the reservoir to the interface for the lubricating.

16. A method comprising:
initiating a rectilinear reciprocation of a piston in a cylinder;
transferring fuel from a fuel chamber of the cylinder to a combustion chamber of the cylinder; and
lubricating an interface of the piston and a wall of the cylinder with a lubrication oil, the cylinder to remain substantially free of the lubrication oil outside of the interface.

17. The method of claim 16 wherein said transferring comprises directing the fuel through a head of the piston.

18. The method of claim 16 wherein said lubricating comprises directing the lubrication oil through a body of the piston and to the interface.

19. The method of claim 16 further comprising exhausting from the combustion chamber and through a head of the piston.

20. The method of claim 19 wherein a portion of said transferring occurs during a portion of said exhausting to allow the fuel to scavange exhaust out of the combustion chamber.
